(19) United States
(12) Patent Application Publication
(10) Pub. No.: US 2026/0270745 A1
(43) Pub. Date: Sep. 10, 2026

(54) WIRELESS SENSING PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Jinhua WU, Beijing (CN)

(21) Appl. No.: 18/873,190

(22) PCT Filed: Jun. 15, 2022
(86) PCT No.: PCT/CN2022/098859

§ 371 Date: Dec. 9, 2024

(51) Int. Cl. H04W 24/10; H04W 4/40; H04W 24/08; H04W 80/04

(52) U.S. Cl. CPC H04W 24/10; H04W 4/40; H04W 24/08; H04W 80/04

(57) ABSTRACT

A wireless sensing processing method is performed by a communication module of a terminal and includes: sending a first request message to a first network device according to module information of at least one sensing module of the terminal; receiving a first response message returned by the first network device based on the first request message; sending a second request message generated based on a first communication configuration to a second network device; and receiving a second response message returned by the second network device based on the second request message, wherein the second response message comprises a sensing configuration; wherein the sensing configuration is configured for the sensing module to generate a sensing result based on wireless sensing and provide the sensing result to a driving assistance system of the terminal.

### CROSS REFERENCE TO RELATED APPLICATION

The present application is a U.S. National Stage of International Application No. PCT/CN2022/098859, filed on Jun. 15, 2022, the content of which is incorporated herein by reference in its entirety.

### TECHNICAL FIELD

The present disclosure relates to, but is not limited to, the field of wireless communication technologies, and in particular to a wireless sensing processing method and apparatus, a communication device and a storage medium.

### BACKGROUND

Wireless sensing technology aims to acquire information about a remote object by transmitting a sensing signal without physically contacting the remote object. After the sensing data (or perception data) of the target or the sensing data of surrounding of the target is analyzed, characteristics of the target and/or characteristics of the environment in which the target is located can be obtained.

Radar is widely used in wireless sensing technology, which uses radar signals to determine the distance, angle, and instantaneous velocity of a target.

Other sensing technologies include non-RF sensors, which may include Time of Flight (ToF) cameras, accelerometers, gyroscopes, and Lidar, and so on.

An integrated sensing and communication system means that sensing capabilities are provided in the fifth generation mobile communication (5G) New Radio (NR), so that the communication systems and infrastructure of 5G NR are used for communication as well as sensing services.

### SUMMARY

A first aspect of an embodiment of the present disclosure provides a wireless sensing processing method. The method is performed by a communication module of a terminal, and the method includes:
sending a first request message to a first network device according to module information of at least one sensing module of the terminal;
receiving a first response message returned by the first network device based on the first request message, wherein the first response message includes a first communication configuration provided for the sensing module, wherein the sensing module has a transmitting capability of transmitting a sensing signal and/or a receiving capability of receiving a reflected signal which is returned based on the sensing signal acting on a sensing target;
sending a second request message generated based on the first communication configuration to a second network device; and
receiving a second response message returned by the second network device based on the second request message, wherein the second response message includes a sensing configuration;
wherein the sensing configuration is used for the sensing module to generate a sensing result based on wireless sensing and provide the sensing result to a driving assistance system of the terminal.

A second aspect of an embodiment of the present disclosure provides a wireless sensing processing method. The method is performed by a sensing module of a terminal, and the sensing module has a capability of transmitting a sensing signal and receiving a reflected signal which is returned based on the sensing signal acting on a sensing target. The method includes: receiving a first communication configuration provided by a communication module of the terminal;
based on the first communication configuration, providing, to the communication module, a second request message to be sent;
receiving, from the communication module, a sensing configuration returned based on a second response message for the second request message;
performing wireless sensing according to the sensing configuration and obtaining a sensing result; and
providing the sensing result to a driving assistance system.

A third aspect of an embodiment of the present disclosure provides a wireless sensing processing method. The method is performed by a first network device, and the method includes:
receiving a first request message sent by a terminal;
returning a first response message to the terminal based on the first request message, wherein the first response message includes a first communication configuration, wherein first communication configurations corresponding to different sensing modules in the terminal are different;
wherein the first communication configuration is used for a communication module of the terminal to obtain, from a second network device, sensing configurations for different sensing modules.

A fourth aspect of an embodiment of the present disclosure provides a wireless sensing processing method. The method includes:
receiving a second request message sent by a terminal, wherein the second request message is sent based on a second communication configuration, and different sensing modules in the terminal correspond to different first communication configurations;
returning a second response message to the terminal based on the second request message, wherein the second response message comprises a sensing configuration, and the sensing configuration is used for a sensing module to obtain a sensing result based on wireless sensing and provide the sensing result to a driving assistance system of the terminal.

A fifth aspect of an embodiment of the present disclosure provides a wireless sensing processing apparatus. The apparatus includes:
a first sending module configured to send a first request message to a first network device according to module information of a sensing module of the terminal;
a first receiving module configured to receive a first response message returned by the first network device based on the first request message, wherein the first response message includes a first communication configuration provided for the sensing module, wherein the sensing module has a transmitting capability of transmitting a sensing signal, and/or a receiving capability of receiving a reflected signal which is returned based on the sensing signal acting on a sensing target;
wherein the first sending module is further configured to send a second request message generated based on the first communication configuration to the second network device;
wherein the first receiving module is further configured to receive a second response message which is returned by the second network device based on the second request message, wherein the second response message includes a sensing configuration;
wherein the sensing configuration is used for the sensing module to generate a sensing result based on wireless sensing, and provide the sensing result to a driving assistance system of the terminal.

A sixth aspect of an embodiment of the present disclosure provides a wireless sensing processing apparatus. The apparatus includes: a second receiving module, a second sending module, an execution module, and a providing module;
the second receiving module is configured to receive a first communication configuration provided by a communication module of a terminal;
the second sending module is configured to, based on the first communication configuration, provide a second request message to the communication module;
the second receiving module is further configured to receive, from the communication module, a sensing configuration based on a second response message for the second request message;
the execution module is configured to perform wireless sensing according to the sensing configuration and obtain a sensing result;
the providing module is further configured to provide the sensing result to a driving assistance system.

A seventh aspect of an embodiment of the present disclosure provides a wireless sensing processing apparatus. The apparatus includes:
a third receiving module configured to receive a first request message sent by a terminal;
a third sending module configured to return a first response message to the terminal based on the first request message, wherein the first response message includes a first communication configuration, wherein first communication configurations corresponding to different sensing modules in the terminal are different;
wherein the first communication configuration is used for a communication module of the terminal to obtain, from the second network device, sensing configurations for different sensing modules.

An eighth aspect of an embodiment of the present disclosure provides a wireless sensing processing apparatus. The apparatus includes:
a fourth receiving module configured to receive a first request message sent by a terminal;
a fourth sending module configured to return a first response message to the terminal based on the first request message, wherein the first response message includes a first communication configuration, wherein first communication configurations corresponding to different sensing modules in the terminal are different;
wherein the first communication configuration is used for a communication module of the terminal to obtain, from a second network device, sensing configurations for different sensing modules.

A ninth aspect of an embodiment of the present disclosure provides a communication device, including a processor, a transceiver, a memory, and an executable program stored in the memory and capable of being run by the processor. When the processor runs the executable program, the wireless sensing processing method provided in any one of the first to fourth aspects is implemented.

A tenth aspect of an embodiment of the present disclosure provides a computer storage medium, which stores an executable program. When the executable program is executed by a processor, the wireless sensing processing method provided in any one of the first to fourth aspects is implemented.

According to the technical solutions provided by the embodiments of the present disclosure, the first network device specially allocates a first communication configuration to a sensing module, and the sensing module can subsequently interact with a network device based on its own communication configuration to perform sensing service-related interactions, thereby reducing problems such as a delay caused by interactions for the communication configuration of the communication module and improving communication efficiency.

It should be understood that the foregoing general description and the following detailed description are illustrative and explanatory only and are not restrictive of the embodiments of the present disclosure.

### BRIEF DESCRIPTION OF THE DRAWINGS

The accompanying drawings, which are incorporated in and constitute a part of the specification, illustrate embodiments consistent with the present disclosure and, together with the specification, serve to explain the principles of the embodiments of the present disclosure.

FIG. 1 is a schematic structural diagram of a wireless communication system according to an example embodiment;

FIG. 2 is a schematic flowchart of a wireless sensing processing method according to an example embodiment;

FIG. 3 is a schematic diagram showing a connection between a vehicle and a network device according to an example embodiment;

FIG. 4 is a schematic flowchart of a wireless sensing processing method according to an example embodiment;

FIG. 5 is a schematic flowchart of a wireless sensing processing method according to an example embodiment;

FIG. 6 is a schematic flowchart of a wireless sensing processing method according to an example embodiment;

FIG. 7 is a schematic flowchart of a wireless sensing processing method according to an example embodiment;

FIG. 8 is a schematic flowchart of a wireless sensing processing method according to an example embodiment;

FIG. 9 is a schematic flowchart of a wireless sensing processing method according to an example embodiment;

FIG. 10 is a schematic structural diagram of a wireless sensing processing apparatus according to an example embodiment;

FIG. 11 is a schematic structural diagram of a wireless sensing processing apparatus according to an example embodiment;

FIG. 12 is a schematic structural diagram of a wireless sensing processing apparatus according to an example embodiment;

FIG. 13 is a schematic structural diagram of a wireless sensing processing apparatus according to an example embodiment;

FIG. 14 is a schematic structural diagram of a terminal according to an example embodiment;

FIG. 15 is a schematic structural diagram of a communication device according to an example embodiment.

### DETAILED DESCRIPTION

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the present disclosure. Rather, they are merely examples of apparatuses and methods consistent with some aspects of embodiments of the present disclosure.

The terms used in embodiments of the present disclosure are for the purpose of describing example embodiments only and are not intended to limit the embodiments of the present disclosure. As used in the present disclosure, the singular forms “a/an”, “said” and “the” are intended to include a plural form as well, unless the context clearly dictates otherwise. It will also be understood that the term “and/or” as used herein refers to and includes any or all possible combinations of one or more of associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, first information may also be called second information, and similarly, second information may also be called first information. Depending on the context, the word “if” as used herein may be interpreted as “when” or “upon” or “in response to determining . . . ”.

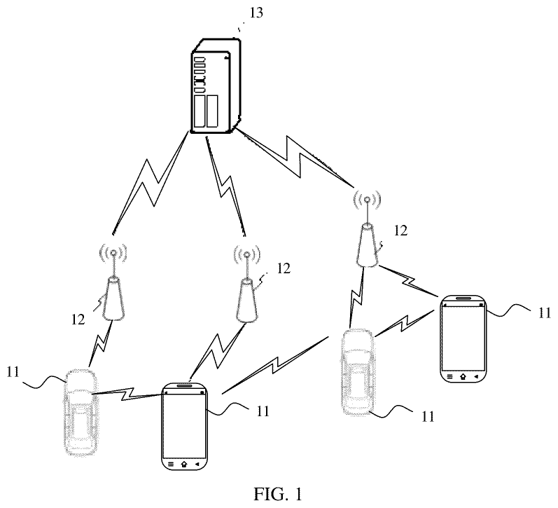

FIG. 1 shows a schematic structural diagram of a wireless communication system provided by an embodiment of the present disclosure. As shown in FIG. 1, the wireless communication system is a communication system based on cellular mobile communication technologies. The wireless communication system may include multiple UEs 11 and multiple access devices 12.

A UE 11 may be a device that provides voice and/or data connectivity to a user. The UE 11 may communicate with one or more core networks via a Radio Access Network (RAN). The UE 11 may be an Internet of Things UE, such as a sensor device, a mobile phone (or referred to as a “cellular” phone), and a computer with an Internet of Things UE, for example, it can be a fixed, portable, pocket-sized, handheld, computer-built-in or vehicle-mounted device. For example, the user equipment 110 may be a station (STA), a subscriber unit, a subscriber station, a mobile station, a mobile, a remote station, an access point, a remote UE (remote terminal), an access UE (access terminal), a user terminal, a user agent, a user device, or user equipment (UE). Alternatively, the UE 11 may be equipment of an unmanned aerial vehicle. Alternatively, the user equipment 110 may be a vehicle-mounted device, for example, it may be an on-board computer with a wireless communication function, or a wireless communication device connected to an external on-board computer. Alternatively, the UE 11 may be a roadside device, for example, it may be a streetlight, a signal light or other roadside device with a wireless communication function.

An access device 12 may be a network side device in a wireless communication system. The wireless communication system may be the 4th generation mobile communication (4G) system, also known as the Long Term Evolution (LTE) system; or, the wireless communication system may be a 5G system, also called new radio (NR) system or 5G NR system. Alternatively, the wireless communication system may be a next-generation system of the 5G system. The access network in the 5G system may be called New Generation-Radio Access Network (NG-RAN). Alternatively, it may be a MTC system.

The access device 12 may be an evolved access device (eNB) used in the 4G system. Alternatively, the access device 12 may be a access device (gNB) using a centralized distributed architecture in the 5G system. When the access device 12 adopts a centralized distributed architecture, it usually includes a central unit (CU) and at least two distributed units (DU). The central unit is provided with a protocol stack including a Packet Data Convergence Protocol (PDCP) layer, a Radio Link Control protocol (RLC) layer, and a Media Access Control (MAC) layer; a distributed unit is provided with a physical (PHY) layer protocol stack. The embodiments of the present disclosure do not limit the specific implementation of the access device 12.

A wireless connection may be established between an access device 120 and a UE 11 through a radio air interface. In different implementations, the radio air interface is a radio air interface based on the fourth generation mobile communication network technology (4G) standard; or, the radio air interface is a radio air interface based on the fifth generation mobile communication network technology (5G) standard, for example, the radio air interface is a new air interface; alternatively, the radio air interface may be a radio air interface based on the next generation mobile communication network technology standard of 5G.

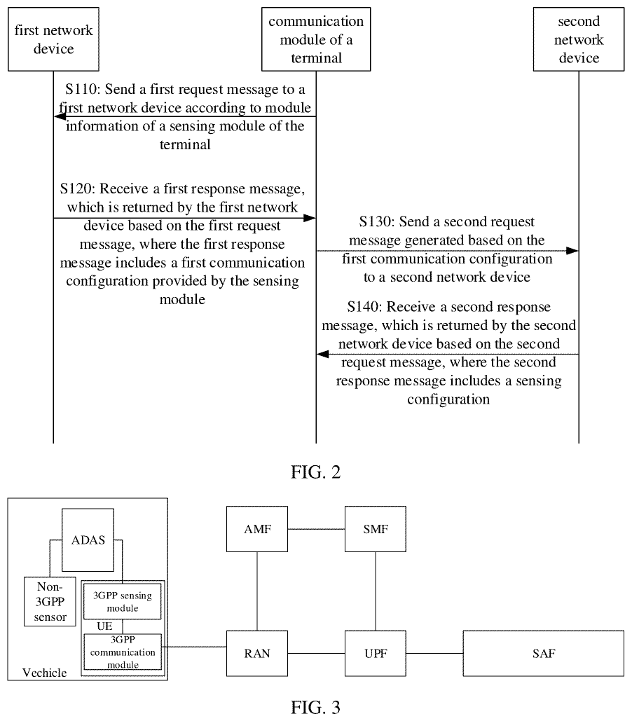

As shown in FIG. 2, an embodiment of the present disclosure provides a wireless sensing processing method. The method is performed by a communication module of a terminal, and the method includes:

In S110, a first request message is sent to a first network device according to module information of a sensing module of the terminal.

In S120, a first response message, which is returned by the first network device based on the first request message, is received. The first response message includes a first communication configuration provided for the sensing module. The sensing module has a transmitting capability of transmitting a sensing signal, and/or a receiving capability of receiving a reflected signal which is returned based on the sensing signal acting on a sensing target.

In S130, a second request message generated based on the first communication configuration is sent to a second network device.

In S140, a second response message, which is returned by the second network device based on the second request message, is received. The second response message includes a sensing configuration.

The sensing configuration is used for the sensing module to generate a sensing result based on wireless sensing, and provide the sensing result to a driving assistance system of the terminal.

In an embodiment of the present disclosure, the terminal may be a means of transportation such as a vehicle or a movable device.

As shown in FIG. 3, the terminal may include a non-3GPP sensor, a 3GPP sensing module, and a 3GPP communication module.

The terminal has a communication module. The communication module may be a 3GPP communication module or a cellular communication module, and can communicate with a Terrestrial Network (TN) or a Non-Terrestrial Network (NTN).

The sensing module is capable of transmitting a sensing signal and receiving a returned reflective signal of the sensing signal acting on a sensing target. The distance between the sensing target and the sensing module can be calculated based on the flight time of the sensing signal, and the angle between the sensing target and the sensing module can be known in conjunction with the transmission angle of the sensing signal and the reception angle of the reflective signal.

In an embodiment of the present disclosure, a communication module and a sensing module may be included inside the terminal. The terminal is connected to a driving assistance system, or the terminal itself is provided with a driving assistance system. The driving assistance system may be an Advanced Driver Assistance System (ADAS).

For example, in an embodiment of the present disclosure, there is an interface between the sensing module and the driving assistance system, and data can be transmitted between them. For example, there is an Application Programming Interface (API) between the sensing module and the driving assistance system to facilitate information exchange between the sensing module and the driving assistance system.

The communication module may include: a communication chip and/or a network card, etc.

A sensing module may include: various radars and/or various sensors capable of transmitting and/or receiving a sensing signal. The terminal may include multiple sensing modules, and these sensing modules can sense a relative location of a sensing target in the same direction and/or different directions.

The communication module of the terminal may send a first request message to the first network device according to module information of the sensing module(s) of the terminal. The first request message may include the module information of the sensing module(s), so that the module information of the sensing module(s) in the terminal can be notified to the network device. As an example, the first network device includes but is not limited to a Session Management Function (SMF). In other embodiments, the first network device may also include but is not limited to an Access Management Function (AMF) or a User Plane Function (UPF).

The module information includes but is not limited to at least one of the following:
a switch status of the sensing module(s);
whether the function of the sensing module(s) is in a normal state;
type information of sensing module(s);
capability information of the sensing module(s);
working status information of the sensing module(s);
information about the number of sensing module(s) in the terminal; or
information about the number of sensing module(s) that is(are) in a working state in the terminal;
information about the number of sensing module(s) in the terminal that is(are) capable of being in the working state.

As an example, the first request message includes but is not limited to: a session establishment message and/or a network registration message sent by the terminal to the first network device.

If the first request message is a session establishment message, before the communication module of the terminal sends the session establishment message, the communication module of the terminal first completes the registration to the network device side through a registration request message.

In some embodiments, the second request message includes but is not limited to a sensing request message. The sensing request message can be used to request a sensing configuration from the second network device.

The second network device may be a Sensing Function (SF) or a Sensing Application Function (SAF).

The sensing configuration includes but is not limited to at least one of the following:
a transmit parameter for the sensing module(s) to transmit the sensing signal;
a receiving configuration for the sensing module(s) to receive the reflected signal;
a processing configuration for the sensing module(s) to process the sensing data based on the reflected signal to obtain the sensing result;
a sensing power configuration; or
a sensing frequency configuration, etc.

The sensing configuration may be an abbreviation of sensing configuration information. The sensing configuration may also be referred to as a sensing parameter.

Of course, the above is just example(s) of sensing configuration, and the specific implementation is not limited to the above example(s).

In the embodiments of the present disclosure, the communication module of the terminal is responsible for interacting with network device(s) to obtain the first communication configuration which is used for subsequent data interaction between the sensing module(s) and the second network device.

The first communication configuration may be any communication configuration provided by the first network device for information interaction between a corresponding sensing module in the terminal and the second network device.

The first communication configuration may include at least one of the following:
an identity of the sensing module(s); the identity of a sensing module includes but is not limited to an IP address of the sensing module or other identity that can be identified by the second network device; or
a message format, etc. One or more fields may be defined in a message format, and these fields may carry various module information of the sensing module(s) and/or sensing configuration(s) provided by the second device.

In an embodiment, all sensing modules in the terminal share a set of first communication configuration(s), and the first communication configuration(s) is(are) different from the second communication configuration of the communication module. In this implementation, the communications of the communication module and sensing module(s) in the terminal with the network device are isolated, which reduces a situation where other non-sensing service data of the communication module occupies too much bandwidth for interactions between the sensing module(s) and the network device.

In another embodiment, different sensing modules in the terminal use different first communication configurations. In this way, the terminal will subsequently distinguish the sensing modules for communication with the second network device, and for each sensing module, the second network device can generate a sensing configuration adapted to the sensing module.

Of course, the above is merely example(s) of the first communication configuration. By way of example, the first communication configuration may also include: a communication bandwidth configuration, and so on.

Different sensing modules have different first communication configurations. For the sensing modules, the second network device can send sensing configurations that match the sensing modules, respectively. In this way, the sensing modules can perform wireless sensing according to the sensing configurations that match themselves. On the other hand, the network devices provide different first communication configurations and sensing configurations for different sensing modules, respectively, so that even the sensing modules in the same terminal can come from different suppliers or have different specifications and sensing capabilities. In this way, the sensing module types, suppliers, and/or capability requirements of the sensing modules in the same terminal can be differentiated.

In some embodiments, the first communication configuration includes: a Internet Protocol (IP) address. The IP addresses corresponding to different sensing modules are different.

In the embodiment of the present disclosure, different sensing modules have different IP addresses. Thus, the same communication module of the terminal sends message(s) for different sensing modules to the network side with different IP addresses. Thus, when network device such as the second network device receives the message(s) sent by the terminal, the network device can determine, at a non-application layer such as a network interface layer, which sensing module(s) of the terminal the message(s) comes(come) from. This can reduce the information interaction delay between the sensing module(s) and the network device and meeting the ultra-low latency requirement in an autonomous driving scenario.

In some embodiments, the first response message further includes: a second communication configuration. The second communication configuration is used for communication of the communication module.

If the first request message is a session establishment message, the first response message may include: a session establishment response message.

The second communication configuration is carried in the session establishment response message.

In an embodiment of the present disclosure, the second communication configuration may also include an IP address allocated to the communication module. If the communication module performs communications with the network device irrelevant to the sensing module(s), the communication module uses its own IP address for communications. For example, when a communication module of a vehicle-mounted device obtains video or audio data from the network device, it may use the communication module's own IP address to communicate with the network device. Alternatively, when the terminal uses the communication module to call other devices, it may also communicate based on its own IP address.

In this way, the communications of the communication module and sensing module(s) in the terminal with the network device are isolated, which reduces a situation where too much other non-sensing service data of the communication module occupies the bandwidth for interactions between the sensing module(s) and the network device.

In some embodiments, the first request message includes at least one of the following:
first information indicating whether the terminal includes the sensing module(s);
second information indicating the number of the sensing module(s) included in the terminal; or
third information indicating the number of the sensing module(s) in the terminal that is(are) turned on.

In some embodiments, the first request message includes the first information, and the first network device allocates at least two sets of communication configurations: one is a set of first communication configuration(s) and the other is a set of second communication configuration(s). In some other scenarios, if the first network device receives the first request message including the first information, and the first request message does not indicate the number of sensing module(s) included in the terminal, the first network device indicates the terminal to report the number of sensing module(s), and the first network device subsequently allocates corresponding set(s) of first communication configuration(s) according to the number of sensing module(s). In other scenarios, if the first request message does not include the second information or the third information and includes the first information alone, the first network device allocates one set of first communication configuration(s) by default. The terminal receives the corresponding sets of first communication configuration(s) in the first response message depending how many set(s) of the first communication configuration(s) is(are) allocated by the first network device.

In some embodiments, the first request message may include the second information or the third information separately, or may include the second information and the third information simultaneously.

For example, the second information may indicate the total number of sensing module(s) included in the terminal. The third information indicates the number of sensing module(s) in a turned-on state.

For example, taking a vehicle as an example, the vehicle may have multiple sensing modules. The multiple sensing modules may be divided into multiple groups, and one group of sensing module(s) may include at least one sensing module. In some cases, one group of sensing module(s) may include multiple sensing modules. One group of sensing module(s) may be used for wireless sensing in one direction of the vehicle.

Assuming that there is a set of sensing modules on the front, back, left and right sides of the vehicle, respectively, and each set of sensing modules perform wireless sensing for the front, back, left and right sides of the vehicle.

If one group of sensing modules have two or more sensing modules, these sensing modules may perform mutual backup of wireless sensing in the direction, or may be used for wireless sensing for angles in the sensing direction.

In some embodiments, the second request message includes at least one of the following:
type information of the sensing module(s);
a sensing field of view of the sensing module(s);
a sensing direction of the sensing module(s);
sensing capability information of the sensing module(s);
sensing demand information;
location information of the terminal;
a motion velocity of the terminal; or
a motion trajectory of the terminal.

Different types of sensing modules have different sensing capabilities. If the type information of the sensing module(s) is provided to the second network device, the second network device can know the sensing capability information of the sensing module(s) based on a correspondence between types of sensing modules and sensing capability information. In this way, the sensing capability information does not need to be reported, thus reducing the signaling overhead of the second request message.

The second request message includes the sensing field of view of each sensing module. For example, the sensing capabilities of different sensing modules are different, and the corresponding sizes of the sensing field of view are also different. The sensing angle of some sensing module(s) is 60 degrees, and the sensing angle of some sensing module(s) is 45 degrees.

For example, a front sensing module of the vehicle is used for wireless sensing in the vehicle's forward direction. A rear sensing module of the vehicle is used for sensing in a direction opposite to the vehicle's forward direction. A left sensing module of the vehicle is used for wireless sensing for the left side of the vehicle. A right sensing module of the vehicle is used for wireless sensing for the right side of the vehicle.

The sensing capability information may be used to describe the sensing capability of a sensing module. For example, the sensing capability information of a sensing module may include but is not limited to at least one of the following:
a radio frequency supported by the sensing module;
the maximum transmit power supported by the sensing module;
the maximum sensing angle of view supported by the sensing module; or
the highest sensing frequency supported by the sensing module.

The sensing demand information may be used to indicate the purpose and/or urgency of the sensing result of the current wireless sensing, for example, reversing, pulling over, assisted driving in different road scenarios, etc.

These pieces of sensing demand information may be used by the second network device to generate a sensing configuration that can meet the current sensing scenario.

The location information of the terminal includes, but is not limited to: the latitude and longitude information of the terminal, a cell where the terminal camps on, and/or a Tracking Area Identifier (TAI).

If the terminal is a vehicle, the motion velocity of the terminal is the driving velocity of the vehicle.

The motion trajectory of the vehicle may include: the instantaneous motion trajectory of the vehicle and/or a planned path of the vehicle. The instantaneous motion trajectory of the vehicle may be the velocity, acceleration and/or direction allowed for the vehicle to continue. The planned path of the vehicle may facilitate the second network device to determine the driving environment of the vehicle, and different driving environments have different sensing demands. Therefore, both the instantaneous motion trajectory of the vehicle and the planned path of the vehicle may be used to generate the sensing configuration.

In some embodiments, the sensing capability information of a sensing module includes at least one of the following:
a sensing model supported by the sensing module;
a radio frequency supported by the sensing module;
a sensing range supported by the sensing module; or
the maximum sensing power supported by the sensing module.

Sensing modules may be differentiated according to different entities that transmit a sensing signal and/or receive a reflected signal.

As an example, the sensing model may include:
a first model in which the terminal transmits a sensing signal and the terminal receives a reflected signal;
a second model in which the terminal transmits a sensing signal and a base station receives a reflected signal; or
a third model in which the base station transmits a sensing signal and the terminal receives a reflected signal.

There are multiple carrier frequencies for wireless sensing. Some sensing modules support more radio frequencies, while others support fewer radio frequencies.

In some embodiments, the sensing range supported by a sensing module may include: the minimum sensing distance and/or the maximum sensing distance that the sensing module can sense.

For example, some Lidars are blind spots for a sensing module at a very close distance. Of course, when a sensing module acts as a transmitter to transmit a sensing signal, the maximum sensing power supported by the sensing module is limited, and thus the maximum sensing distance of the corresponding sensing module is also limited.

In some cases, the maximum sensing power supported by a sensing module may also affect sensing accuracy of the sensing module. If there is interference under the transmit power supported by the sensing module, sensing is affected by the interference signal, resulting in inaccurate ranging distance.

After the above-mentioned sensing capability information is reported to the second network device, the second network device may configure a corresponding sensing configuration for a corresponding sensing module according to the sensing capability information.

In some embodiments, the sensing demand information indicates at least one of the following:
a radio frequency expected to be used;
a sensing signal transmit frequency expected to be used; or
required accuracy of the sensing result.

For example, a sensing module has a capability of both transmitting a sensing signal and receiving a reflected signal. Therefore, when the sensing module does not transmit the sensing signal, it can receive a sensing signal sent by other device, thereby knowing a radio frequency used by an interference signal in the current sensing environment. Thus, the sensing module may indicate a radio frequency it expects to use through the sensing demand information.

A sensing signal may be a wireless signal pulse. For example, the wireless signal pulse may include but is not limited to: a laser pulse and/or a radar signal pulse. In this way, the wireless signal pulse is transmitted in a certain period during the transmitting procedure, rather than being transmitted continuously. Since the generation of the wireless signal pulse requires certain device time, this has a certain requirement on the device, and thus the device may give a sensing signal transmit frequency the device expects to use according to its own capability.

In addition, different sensing scenarios require different accuracy of sensing results. Therefore, the required accuracy of the sensing result may be informed to the second network device, and the second network device can be assisted in generating a sensing configuration that can enable the sensing result to reach the accuracy.

In some embodiments, sending, to the second network device, the second request message which is generated based on the first communication configuration includes:
if the driving assistance system has a demand to obtain the sensing result, sending, to the second network device, the second request message which is generated based on the first communication configuration.

If the driving assistance system has the demand to obtain the sensing result, the communication module of the terminal sends the second request message to the second network device; otherwise, the second request message is not sent.

In some embodiments, a source IP address of the second request message is an IP address specified by the first communication configuration, and thus the source address used by a data packet corresponding to the second request message may be the IP address defined by the first communication configuration.

In some embodiments, the driving assistance system having the demand to obtain the sensing result includes at least one of the following:
the driving assistance system entering a working state;
the motion velocity of the terminal reaching a preset velocity; or
the sensing module and/or the communication module receiving, from the driving assistance system, demand information for obtaining the sensing result.

For example, after the driving assistance system is started and enters the working state, it means that the driving assistance system currently has a demand for consuming the sensing result.

Safety issues become prominent only when the terminal's motion velocity reaches a certain velocity. Therefore, when the terminal's motion velocity reaches the preset velocity, it means that the driving assistance system is about to enter the working state, or has entered the working state.

The preset velocity may be 0 or other value.

For example, if the driving assistance system has a demand to obtain the sensing result, it sends sensing demand information to the sensing module.

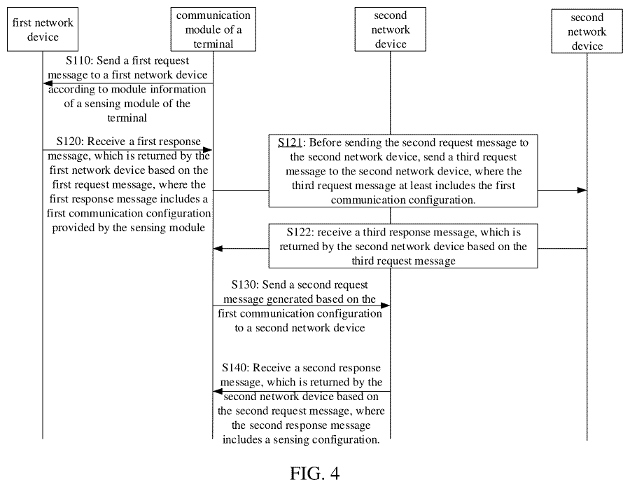

In some embodiments, as shown in FIG. 4, the method further includes:

In S121, before sending the second request message to the second network device, a third request message is sent to the second network device. The third request message at least includes the first communication configuration.

In S122, a third response message, which is returned by the second network device based on the third request message, is received.

In the embodiment of the present disclosure, before sending the second request message to the second network device, the communication module sends the third request message to the second network device. The third request message may be a registration request message for the sensing module, and the module information of the sensing module and the first communication configuration may be sent to the second network device through the registration request message.

As an example, the first communication configuration may at least be sent to the second network device through the third request message. In this way, the second network device receives the third request message before receiving the second request message. Based on the first communication configuration received through the third request message, the second network device can directly determine, based on the source IP address, etc., which sensing module the second request message involves when receiving the second request message.

In some embodiments, the third request message further includes at least one of the following:
type information of the sensing module(s);
sensing field of view of the sensing module(s);
a sensing direction of the sensing module(s); or
sensing capability information of the sensing module(s).

For the type information of the sensing module(s) here, reference can be made to the aforementioned embodiments, and repeated descriptions will be omitted here.

For example, the second network device may configure a specific sensing field of view for each sensing module based on the number of sensing modules currently possessed by the terminal and the sensing field of view supported by each sensing module.

Therefore, the sensing field of view of a sensing module (for example, the sensing field of view) may be expressed by a sensing field angle of view.

One of the sensing capability information and type information may be separately reported, or both the sensing capability information and type information may be provided to the second network device at the same time.

If the terminal sends the third request message to the second network device before sending the second request message, and there is reported information in the third request message, there is no need to report it additionally in the second request message.

If the terminal does not send the third request message to the second network device before sending the second request message, that is, the communication module of the terminal directly sends the second request message to the second network device, the second request message may be sent using the first communication configuration, and may also carry the type information, sensing field of view, sensing direction and/or sensing capability information of the sensing module(s).

In some embodiments, the sensing configuration includes at least one of the following:
a sensing parameter;
a validity period of the sensing parameter; or
information for an update trigger event.

The sensing parameter may be any parameter in the aforementioned transmission configuration, reception configuration and/or processing configuration.

The validity period may be as follows: the second network device sets a validity period for the sensing configuration issued by the second network device, and the sensing parameter is only effective within the validity period; if the validity period expires, the sensing parameter becomes invalid.

In some cases, the sensing parameter may not be configured with a validity period but may be configured separately with information for a trigger event. In this way, when occurrence of the trigger event is detected, the sensing module re-requests the sensing configuration from the second network device. In this way, the validity period of one set of sensing configuration(s) is within a time period when a next set of sensing configuration(s) arrives.

In some other cases, a sensing configuration may include both the validity period and information for a trigger event. In this case, if the validity period expires and/or the trigger event is detected, the terminal requests the sensing configuration from the network device again.

As an example, the sensing configurations for different sensing modules are different, and the validity periods of different sensing modules are also different. As an example, the validity period of a sensing configuration for a sensing module that provides to the driving assistance system a sensing result with a higher requirement can be set slightly shorter, and the sensing configuration can be updated at a higher frequency, so that the currently used sensing configuration meets the requirement of the sensing module.

For example, taking a vehicle as an example, the validity period of a sensing configuration for providing a sensing result of the vehicle's forward direction may be shorter than the validity period of a sensing configuration for providing a sensing result of the vehicle's backward direction.

The trigger event may be any event indicating that the sensing configuration is no longer applicable. For example, if one of multiple sensing modules of the terminal fails and can no longer perform wireless sensing, the actual sensing field of view of other sensing modules may need to be increased, which requires the second network device to re-send the sensing configuration to achieve this.

Of course, the above is only an example to illustrate the validity period and triggering event for the sensing configuration, and the specific implementation is not limited to this.

In some embodiments, the method further includes:
when the validity period of the sensing parameter expires or the update trigger event occurs, resending the second request message to the second network device.

For example, the terminal may maintain a timer according to the validity period. If the timer expires, the validity period of the sensing parameter becomes invalid, and the corresponding sensing module may re-request a sensing configuration from the second network device.

For another example, if the entire terminal or a specific sensing module detects a trigger event, it may be considered that a sensing configuration needs to be re-requested. If the terminal or the sensing module receives a new sensing configuration, the old sensing configuration becomes invalid even if the old sensing configuration is within the validity period.

In some embodiments, the update trigger event includes at least one of the following:
a sensing interference being greater than an interference threshold;
accuracy of the sensing result being less than an accuracy threshold; or a congestion status at the location of the terminal meeting a preset congestion condition.

For example, when a vehicle is moving and enters a wireless environment where many devices transmit sensing signals for performing sensing, this inevitably leads to an increase in sensing interference. At this time, in order to obtain a better sensing result, the transmit power of the sensing module(s) in the terminal may be increased or the transmit time of the sensing signal may be adjusted, etc., which are all closely related to the sensing configuration.

For example, the re-requested sensing configuration may include a sensing configuration of a full set of sensing parameters, or may be a sensing configuration that only includes sensing parameter(s) that needs(need) to be updated.

As an example, if the sensing interference is greater than the interference threshold, the mutual interference with other devices can be avoided by adjusting a sensing start time moment of the sensing module(s) in each sensing period. The re-requested or re-received sensing configuration may only include a sensing time offset, and the sensing period, etc. may still use the old sensing configuration, or may be determined based on the old sensing configuration.

For example, if the accuracy of the sensing result drops rapidly, it may be due to a fault in the sensing module itself or a significant change in the sensing environment. Therefore, the current sensing configuration may need to be updated.

If the terminal is a vehicle and if there is congestion currently, the distance between vehicles is very small, and it is unnecessary to continuously keep sensing on, which may only result in unnecessary power consumption, or the sensing configuration for wireless sensing when the vehicle switches from a non-congested driving scenario to a congested scenario also needs to change accordingly. Therefore, if it is detected that the congestion status at the location of the terminal meets the preset congestion condition, it can also be considered that a trigger event is detected.

In some embodiments, the sensing configuration is provided by the second network device when the terminal is authorized for sensing.

Whether the terminal has subscribed a wireless sensing service is determined; if the terminal has not subscribed a wireless sensing service, the second network device can refuse to provide a sensing configuration for the sensing module(s). If the terminal has subscribed a wireless sensing service, the second network device provide sensing configuration(s) for one or more sensing module(s) in the terminal based on the second request message.

If the terminal is not authorized for sensing, the second response message may be a reject message, and the reject message does not contain a sensing configuration. If the terminal receives the reject message, the reject message does not contain a sensing configuration.

In some embodiments, the second response message received by the terminal is an accept message. If it is an accept message, the accept message includes the sensing configuration(s).

In some embodiments, the method further includes:
providing the first communication configuration to a corresponding sensing module; and
receiving the second request message and/or the third request message generated by the sensing module based on the first communication configuration.

In some embodiments, both the second request message and the third request message may be generated by the sensing module itself, and the communication module only transmits the messages transparently.

In some other embodiments, the second request message and the third request message may be generated by the communication module, that is, the sensing module may provide, to the communication module, a message content of the second request message and/or the third request message to be generated by the communication module.

Therefore, in some embodiments, the method further includes:
obtaining, from the sensing module, an information content carried by the third request message; and
according to the first communication configuration, generating the third request message to be sent to the second network device.

In some other embodiments, the method further includes:
obtaining, from the sensing module, an information content carried by the second request message; and
according to the first communication configuration, generating the second request message to be sent to the second network device.

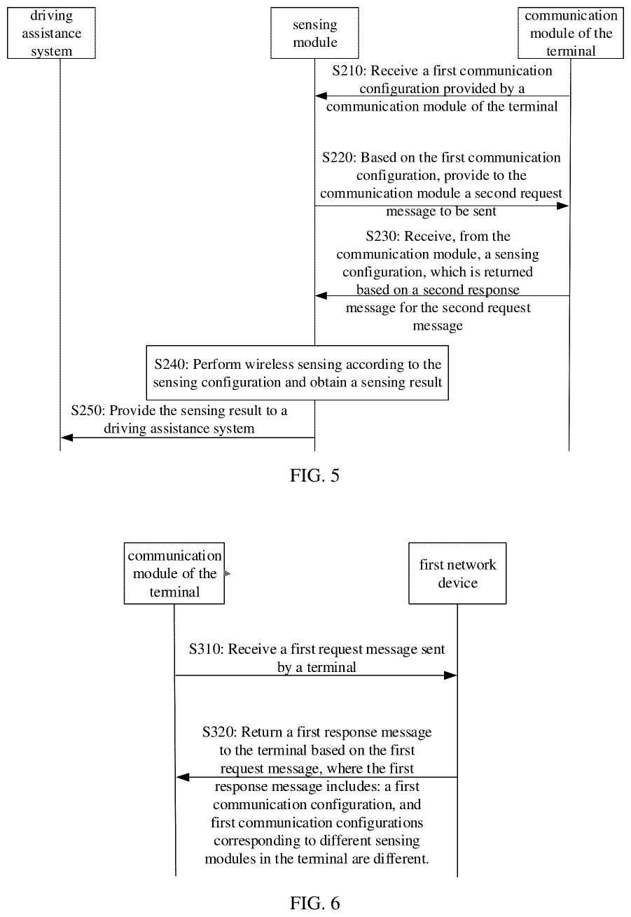

As shown in FIG. 5, an embodiment of the present disclosure provides a wireless sensing processing method. The method is performed by a sensing module of a terminal. The sensing module has a capability of transmitting a sensing signal and receiving a reflected signal which is returned based on the sensing signal acting on a sensing target. The method includes:

In S210, a first communication configuration provided by a communication module of the terminal is received.

In S220, based on the first communication configuration, a second request message is provided to the communication module.

In S230, a sensing configuration, which is returned based on a second response message for the second request message, is received from the communication module.

In S240, wireless sensing is performed according to the sensing configuration and a sensing result is obtained.

In S250, the sensing result is provided to a driving assistance system.

The terminal includes a sensing module, and if the sensing module itself generates the first request message and the second request message and decodes the second response message and the third response message, the communication module provides the first communication configuration to the sensing module after the communication module receives the first communication configuration.

As an example, the first communication configuration may include at least: an IP address allocated by the first network device to a corresponding sensing module.

As another example, the first communication configuration may further include: a message format, and so on.

After receiving the first communication configuration, a second request message is sent to the communication module, and the communication module forwards the second request message to the second network device. When the second network device receives the second request message, there will be a second response message. The sensing configuration is carried in the second response message and provided to the terminal. After the communication module receives the second response message, the communication module of the terminal may transmit the second response message transparently to the sensing module, or the communication module of the terminal may extract the sensing configuration from the second response message and provide it to the sensing module.

If the sensing module performs wireless sensing according to the sensing configuration, the sensing module obtains a sensing result. After obtaining the sensing result, the sensing module provides the sensing result to the driving assistance system for consumption.

In some embodiments, the method further includes:
after receiving the first communication configuration, sending a third request message to the communication module; and
receiving, from the communication, a completion notification provided based on a third response message for the third request message.

The sensing module has a demand for wireless sensing. After receiving the first communication configuration, the sensing module sends a third request message to the communication module according to the first communication configuration. The third request message here is equivalent to a registration request message sent by the sensing module to the second network device. If the communication module receives the third response message returned by the second network device, the third response message may be transparently transmitted to the sensing module, or, as in the embodiment of the present disclosure, a completion notification may be provided to the sensing module after receiving the third response message.

In some embodiments, the information of the third request message includes at least: the first communication configuration; the third request message further includes at least one of the following:
a sensing field of view of the sensing module;
a sensing direction of the sensing module; or
sensing capability information of the sensing module.

If the third request message includes the first communication configuration, it is equivalent to informing the second network device of the first communication configuration during the procedure in which the sensing module registers to the second network device. This can facilitate subsequent communication between the terminal and the second network device with respect to each sensing module.

If the third request message further includes one or more of the above-Attorney mentioned sensing field of view, sensing direction, sensing capability information, etc., when the terminal sends the second request message to the second network device, the carried message content can be reduced.

Specifically, for the related description of the sensing field of view, sensing direction, and sensing capability information, reference may be made to any of the aforementioned embodiments.

In some embodiments, the information required for the second request message includes at least one of the following:

The sensing field of view of the sensing module;
a sensing direction of the sensing module;
sensing capability information of the sensing module;
sensing demand information;
location information of the terminal;
a motion velocity of the terminal; or
a motion trajectory of the terminal.

If the information required for the second request message may include one of the above information, the sensing module itself may encapsulate the information to obtain the second request message, or the sensing module may provide the information required for the second request message to the communication module, which encapsulates the information provided by the sensing module into the second request message.

In some embodiments, the sensing configuration includes at least one of the following:
a sensing parameter;
a validity period of the sensing parameter;
information for an update trigger event.

The sensing parameter may be any parameter in the aforementioned transmission configuration, reception configuration and/or processing configuration.

The validity period may be as follows: the second network device sets a validity period for the sensing configuration issued by the second network device, and the sensing parameter is only effective within the validity period; if the validity period expires, the sensing parameter becomes invalid.

In some cases, the sensing parameter may not be configured with a validity period but may be configured separately with information for a trigger event. In this way, when a trigger event is detected, the sensing module re-requests a sensing configuration from the second network device. In this way, the validity period for one set of sensing configuration(s) is within a time period when a next set of sensing configuration(s) arrives.

In some other cases, the sensing configuration may include both the validity period and information about the trigger event. In this case, if the validity period expires and/or the trigger event is detected, the terminal requests the sensing configuration from the network device again.

In some embodiments, the method further includes:
when the validity period of the sensing parameter expires or the update trigger event occurs, resending information of the second request message to the communication module.

If the sensing module detects that the validity period of the sensing parameter has expired, it can be considered that the sensing parameter is invalid and it is needed to re-request sensing information. Therefore, the sensing module resends a second request message to the communication module. After the second request message is transmitted by the communication module to the second network device, the sensing configuration re-issued by the second network device may be received.

As an example, the update trigger event includes at least one of the following:
a sensing interference being greater than an interference threshold;
accuracy of the sensing result being less than an accuracy threshold; or
a congestion status at the location of the terminal meeting a preset congestion condition.

For example, when a vehicle is moving and enters a wireless environment where many devices transmit sensing signals for sensing, this inevitably leads to an increase in sensing interference. At this time, in order to obtain a better sensing result, the transmit power of the sensing module in the terminal may be increased or the transmit time of the sensing signal may be adjusted, etc., which are all closely related to the sensing configuration.

For example, the re-requested sensing configuration may include a sensing configuration of a full set of sensing parameters, or may be a sensing configuration that only includes sensing parameter(s) that needs(need) to be updated.

As an example, if the sensing interference is greater than the interference threshold, the mutual interference with other devices may be avoided by adjusting the sensing start time moment of the sensing module in each sensing period. The re-requested or re-received sensing configuration may only include a sensing time offset, and the sensing period, etc. may still use the old sensing configuration, or may be determined based on the old sensing configuration.

For example, if the accuracy of the sensing result drops rapidly, it may be due to a fault in the sensing module itself or a significant change in the sensing environment. Therefore, the current sensing configuration may need to be updated.

As shown in FIG. 6, an embodiment of the present disclosure provides a wireless sensing processing method. The method is performed by a first network device. The method includes:

In S310, a first request message sent by a terminal is received.

In S320, a first response message is returned to the terminal based on the first request message. The first response message includes: a first communication configuration. First communication configurations corresponding to different sensing modules in the terminal are different.

The first communication configuration is used for the communication module of the terminal to obtain the sensing configurations for different sensing modules from the second network device.

The first network device may be a core network device, and specifically the core network device includes but is not limited to an SMF.

In some embodiments, after receiving the first request message sent by the terminal, the first response message is returned to the terminal. The first request message may be: any message for requesting a communication configuration.

As an example, the first request message may be a registration request message and/or a session request message and/or a session update message, etc.

The first request message received by the first network device may be sent by the terminal according to the module information of its own sensing module(s). In this way, the first request message may include any information related to the sensing module(s) in the terminal.

In this way, according to the first request message, the first response message may be generated specifically for the sensing configuration(s) of the sensing module(s) included in the terminal.

In some embodiments, the first response message further includes: a second communication configuration, where the second communication configuration is used for communication of the communication module.

In the embodiment of the present disclosure, the first network device also generates the second communication configuration for the communication module of the terminal, where the second communication configuration is a communication configuration for the communication module of the terminal.

Likewise, the second communication configuration may include at least: an IP address.

In some embodiments, the first request message includes at least one of the following:
first information indicating whether the terminal includes a sensing module;
second information indicating the number of sensing module(s) included in the terminal;
third information indicating the number of sensing module(s) in the terminal that is(are) turned on.

In some embodiments, the first request message includes the first information, and the first network device allocates at least two sets of communication configurations, one is a set of first communication configuration(s) and the other set is the second communication configuration(s).

In some other scenarios, if the first network device receives the first request message containing the first information and the first request message does not indicate the number of sensing module(s) included in the terminal, the first network device indicates the terminal to report the number of sensing module(s), and subsequently allocate the corresponding number of sets of first communication configuration(s) based on the number of sensing module(s).

In some other scenarios, if the first request message does not include the second information or the third information and includes the first information alone, the first network device allocates a set of first communication configuration(s) by default. The terminal receives the corresponding number of sets of first communication configuration(s) in the first response message according to the number of sets of first communication configurations allocated by the first network device.

In some embodiments, the first request message may include the second information and the third information separately, or may include the second information and the third information simultaneously.

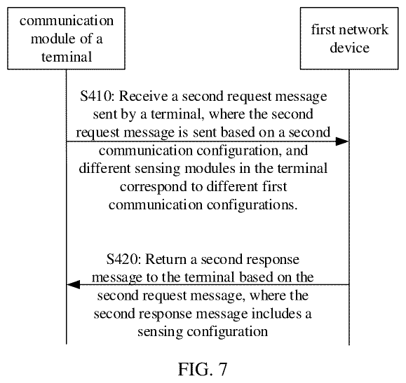

As shown in FIG. 7, an embodiment of the present disclosure provides a wireless sensing processing method. The method is performed by a second network device. The method includes:

In S410, a second request message sent by a terminal is received. The second request message is sent based on a second communication configuration. Different sensing modules in the terminal correspond to different first communication configurations.

In S420, a second response message is returned to the terminal based on the second request message. The second response message includes a sensing configuration. The sensing configuration is used by a sensing module to obtain a sensing result based on wireless sensing and provide the sensing result to a driving assistance system of the terminal.

The second network device here may be SF or SAF. After receiving the second request message, the SF or SAF returns a second response message to the terminal.

The second response message may be: a reject message and/or an accept message.

If the second network device refuses to provide the sensing configuration to the terminal, the second response message may be a reject message.

If the second network device agrees to provide the terminal with the sensing configuration, the second response message may be an accept message. If the second response message is the accept message, the accept message may include the sensing configuration.

In some embodiments, the method further includes:
receiving a third request message from the terminal, wherein the third request message includes: a second communication configuration of the sensing module(s);
returning a third response message to the terminal based on the third request message.

The third request message may be, but is not limited to, a registration request message of the sensing module(s).

If the third request message packet may contain the second communication configuration of the sensing module(s), the second network device may subsequently distinguish whether the message sent by the terminal is directed to the sensing module(s) based on the second communication configuration provided by the third request message.

In some embodiments, the method further includes:
authenticating the terminal;
returning the second response message to the terminal based on the second request message includes:
after the terminal is authenticated, returning the second response message to the terminal based on the second request message.

As an example, the second network device may authenticate the terminal according to the subscription data of the terminal. If the terminal has the authority to obtain the sensing service provided by the network device and/or assist in providing the sensing service, the authentication of the terminal is considered to be passed; otherwise, the authentication of the terminal is considered to fail.

In the embodiment of the present disclosure, the second response message is returned to the terminal based on the second request message, and the second response message includes the aforementioned sensing configuration.

In some embodiments, the information of the third request message includes at least one of:
the first communication configuration;
a sensing field of view of the sensing module(s);
a sensing direction of the sensing module(s);
sensing capability information of the sensing module(s).

As an example, the first communication configuration may include at least one of the following:
identity(identities) of the sensing module(s); the identity of a sensing module includes but is not limited to the IP address of the sensing module or other identity that can be identified by the second network device;
a message format, etc. One or more fields may be defined in a message format, and these fields may carry module information of various sensing modules and/or sensing configuration(s) provided by the second device.

Different sensing modules have different sensing capabilities, and thus the corresponding sizes of sensing field of view are also different. Some sensing modules have a sensing angle of 60 degrees, while others have a sensing angle of 45 degrees.

The sensing directions of different sensing modules may be different. For example, if a certain sensing module faces the forward direction of the vehicle, the sensing direction of the sensing module is the forward direction. If a certain sensing module faces the backward direction of the vehicle, the sensing direction of the sensing module is the backward direction. If a certain sensing module faces the side of the vehicle, the sensing direction of the vehicle is the side direction.

In some embodiments, the information required by the second request message includes at least one of the following:
a sensing field of view of the sensing module(s);
a sensing direction of the sensing module(s);
sensing capability information of the sensing module(s);
sensing demand information;
location information of the terminal;
a motion velocity of the terminal;
a motion trajectory of the terminal.

As an example, the sensing configuration includes at least one of the following:
a sensing parameter;
a validity period of the sensing parameter;
information for an update trigger event.

For the description of the above parameters, reference can be made to the corresponding embodiments mentioned above, and repeated description will be omitted here.

In terms of sensing, how mobile network can assist the 3GPP New Radio (NR) sensing capable User Equipment (UE) in a vehicle as self-transmitter/receiver to support Advanced Driver Assistance System (ADAS)?

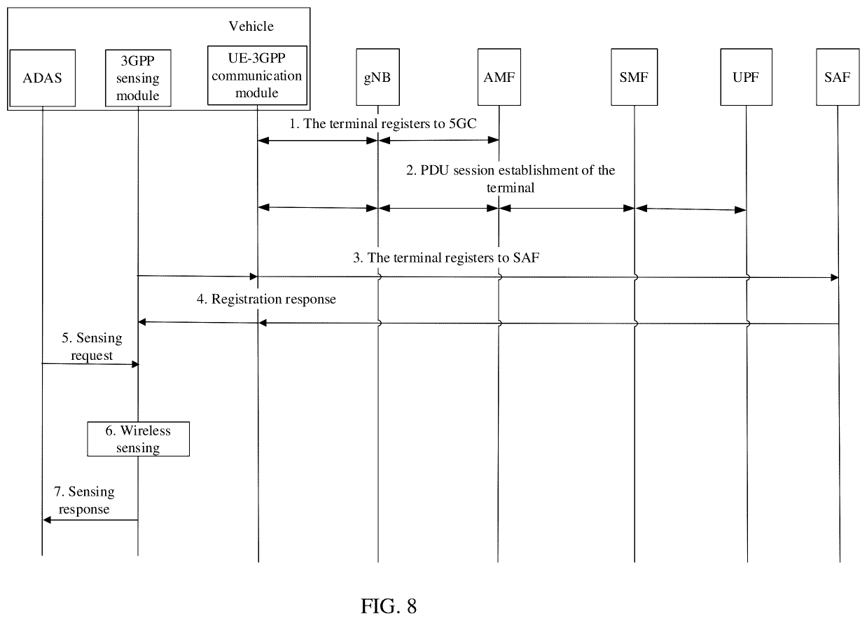

3GPP sensing can be applied to vehicles, and a sensing processing method using sensing module(s) with a 3GPP sensing capability may be shown in FIG. 8. The method may include:
1. A terminal registers to a 5G core network (5GC). Specifically, the 3GPP sensing module performs sensing as transmitter and/or receiver using 3GPP technologies (e.g. NR). The sensing module may provide sensing data to the ADAS as input. The sensing module is connected to a sensing application function server for sensing control purposes. As an example, a UE-3GPP communication module sends a registration request to an AMF via a gNB (RAN), including parameters such as a registration type, SUCI or 5G-GUTI or PEI, security parameter(s), etc. After authentication and authorization of the terminal is completed, the AMF sends “Registration Accept” to the terminal to complete the terminal registration.
2. A PDU session of the terminal is established. As an example, the 3GPP communication module is a module for communicating with a 3GPP network, at least supporting registration, establishing a Protocol Data Unit (PDU) session with the 3GPP network, and sending/receiving traffic (such as IP data) to/from the network. For example, the UE-3GPP communication module initiates the UE requested PDU session establishment procedure by transmitting a NAS message containing a PDU session establishment request within the N1 SM container. The AMF receives the PDU session establishment request sent by the terminal and sends it to the SMF. The SMF sends an “N4 Session Establishment Request” to the UPF to establish a new PDU session for the terminal. The SMF allocates and sends a new IP address to the terminal via the AMF and gNB.

Non-3GPP sensors include but are not limited to: a millimeter wave radar, Lidar, monocular/stereoscopic camera and satellite navigation. The non-3GPP sensors can provide sensing data input for ADAS.
3. If the terminal contains a 3GPP sensing module, the terminal registers with a SAF. The Sensing Application Function (SAF) is owned or trusted by a mobile operator, for example, the sensing application owner has a trusted business and technical relationship with the mobile operator. The terminal may be authenticated and authorized for sensing. The sensing parameters in the UE (such as location, range, time, radio frequency) are also configured by the SAF. The ADAS is the sensing originator and consumer. The ADAS sends a sensing request to the UE's sensing module and receives and consumes the sensing data from the UE's sensing module. For example, the UE-3GPP sensing module initiates a registration with the SAF for sensing, and the registration request may include its UE ID (such as SUPI/MSISDN) and sensing capability, such as supported sensing frequency/power, sensing ranging, or supported sensing mode.
4. After sending the registration response in step 3, a registration response is received. For example, the SAF authorizes the terminal for sensing, accepts the terminal registration, and responds to the terminal indicating successful registration, including the authorized sensing radio frequency/power, sensing ranging, or sensing mode.
5. The sensing module receives the sensing request sent by the ADAS; when the vehicle needs sensing its surrounding environment, such as driving on the road, the ADAS sends the sensing request to the sensing module of the UE to request for sensing data input.
6. The wireless sensing is performed based on the sensing configuration carried in the sensing response. The UE-3GPP sensing module performs sensing as requested by the ADAS and the parameters/configurations authorized by the SAF.
7. The sensing result of the wireless sensing is returned to the ADAS in the form of a sensing response. As an example, the UE-3GPP sensing module reports the sensing data to the ADAS.

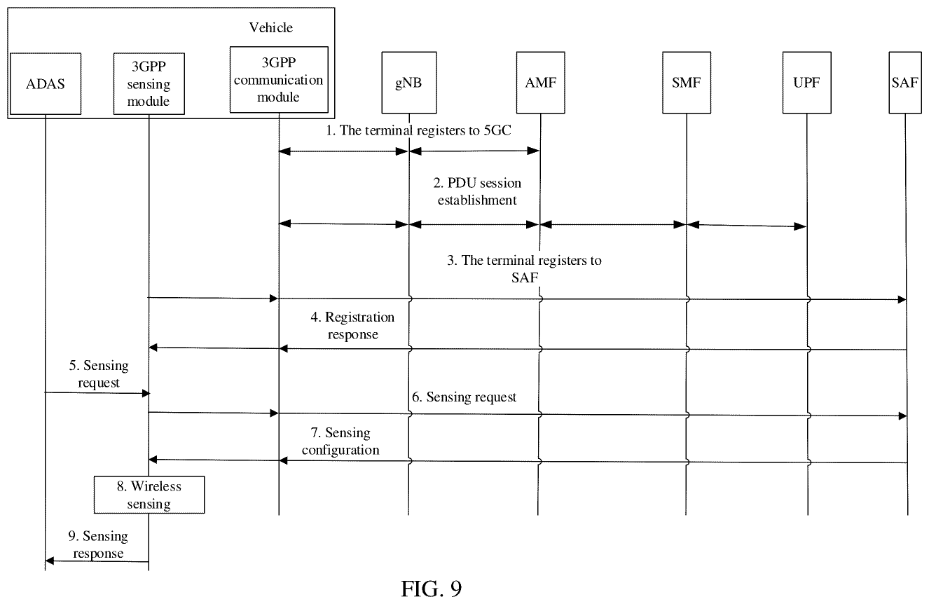

Referring to FIG. 9, an embodiment of the present disclosure provides a wireless sensing method, which may include:
1. The UE-3GPP communication module sends a registration request to an AMF via a gNB (RAN), including parameters such as registration type, SUCI or 5G-GUTI or PEI, security parameter(s), etc. After the authentication and authorization of the terminal is completed, the AMF sends a “Registration Accept” to the terminal to complete the terminal registration.
2. The UE-3GPP communication module initiates the UE requested PDU session establishment procedure by transmitting a NAS message containing a PDU session establishment request in the N1 SM container. The AMF receives the PDU session establishment request from the terminal and sends it to the SMF. The SMF sends an “N4 Session Establishment Request” to the UPF to establish a new PDU session for the terminal. The SMF allocates and sends a new IP address to the terminal via the AMF and gNB.
3. The UE-3GPP sensing module initiates registration to the SAF for sensing. The registration request includes the UE ID (such as SUPI/MSISDN).
4. According to a policy pre-configured by the operator in the SAF, the SAF accepts the terminal registration and responds to the terminal indicating the successful registration.
5. When the vehicle needs sensing its surrounding environment, such as when driving on a road, the ADAS sends a sensing request to the sensing module of the UE to request for sensing data input, which may include a driving trajectory generated based on the original location and target location input by the driver.
6. The UE-3GPP sensing module sends a sensing request to the SAF. The sensing request may include: a sensing mode, a sensing location, a driving trajectory, a sensing range (for example, max 50 meters), the effective time of the sensing configuration (for example, 30 minutes).
7. According to the pre-configured policy in the SAF, the SAF authorizes the terminal's request and sends the sensing configuration to the UE. For example, the sensing configuration may be generated according to the configuration recommended by the terminal, or may be generated by the SAF.
8. The UE-3GPP sensing module performs sensing as requested by the ADAS and the parameters/configuration authorized by the SAF.
9. The UE-3GPP sensing module reports the sensing data to the ADAS.

3GPP-based sensing technologies such as New Radio (NR) can be used to enhance ADAS. 5G system-assisted sensing operations can improve the reliability and quality of the ADAS.

A vehicle includes: 3GPP sensing module(s), 3GPP communication module(s), and interface(s) with ADAS/non-3GPP sensing module.

New procedure: the sensing for ADAS in the vehicle works with the assistance of the 3GPP network.

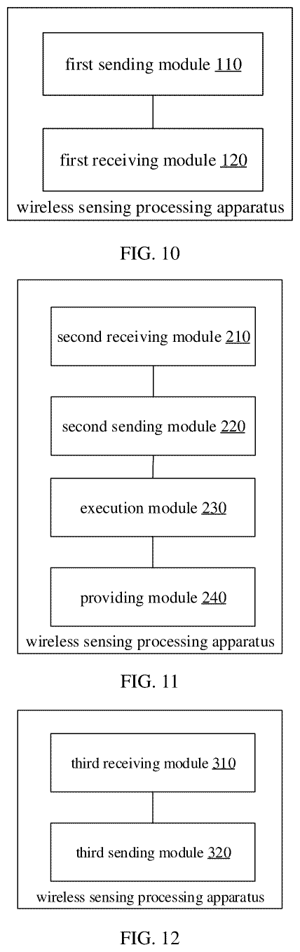

As shown in FIG. 10, an embodiment of the present disclosure provides a wireless sensing processing apparatus. The apparatus includes a first sending module 110 and a first receiving module 120.

The first sending module 110 is configured to send a first request message to a first network device according to module information of a sensing module of the terminal.

The first receiving module 120 is configured to receive a first response message returned by the first network device based on the first request message, wherein the first response message includes a first communication configuration provided for the sensing module, wherein the sensing module has a transmitting capability of transmitting a sensing signal and/or a receiving capability of receiving a reflected signal which is returned based on the sensing signal acting on a sensing target.

The first sending module 110 is further configured to send a second request message generated based on the first communication configuration to a second network device.

The first receiving module 120 is further configured to receive a second response message which is returned by the second network device based on the second request message, wherein the second response message includes a sensing configuration;
wherein the sensing configuration is used for the sensing module to generate a sensing result based on wireless sensing and provide the sensing result to a driving assistance system of the terminal.

In some embodiments, the wireless sensing processing apparatus may be included in a terminal, for example, the terminal is a vehicle.

In some embodiments, the first sending module 110 and the first receiving module 120 may be program modules; after the program modules are executed by a processor, the operations of the above modules can be implemented.

In some embodiments, the first sending module 110 and the first receiving module 120 may be a combination of software and hardware modules; the combination of software and hardware modules includes but is not limited to: a programmable array; the programmable array includes but is not limited to a field programmable array and/or a complex programmable array.

In some other embodiments, the first sending module 110 and the first receiving module 120 may also include pure hardware modules, and the pure hardware modules include but are not limited to: application specific integrated circuits.

In some embodiment, the first communication configuration includes an Internet Protocol (IP) address, and IP addresses corresponding to different sensing modules are different.

In some embodiment, the first response message further includes a second communication configuration, and the second communication configuration is used for communication of the communication module.

In some embodiment, the first request message includes at least one of:
first information indicating whether the terminal includes the sensing module;
second information indicating the number of the sensing module included in the terminal; or
third information indicating the number of sensing module in the terminal that is turned on.

In some embodiment, the second request message includes at least one of:
type information of the sensing module;
a sensing field of view of the sensing module;
a sensing direction of the sensing module;
sensing capability information of the sensing module;
sensing demand information;
location information of the terminal;
a motion velocity of the terminal; or
a motion trajectory of the terminal.

In some embodiment, the sensing capability information includes at least one of:
a sensing model supported by the sensing module;
a radio frequency supported by the sensing module;
a sensing range supported by the sensing module; or
a maximum sensing power supported by the sensing module.

In some embodiment, the sensing demand information indicates at least one of:
a radio frequency expected to be used;
a sensing signal transmit frequency expected to be used; or
required accuracy of the sensing result.

In some embodiment, the first sending module 110 is configured to: if the driving assistance system has a demand for obtaining the sensing result, send the second request message generated based on the first communication configuration to the second network device.

In some embodiment, the driving assistance system having the demand for obtaining the sensing result includes at least one of:
the driving assistance system entering a working state;
a motion velocity of the terminal reaching a preset velocity; or
the sensing module and/or the communication module receiving, from the driving assistance system, demand information for obtaining the sensing result.

In some embodiment, the first sending module 110 is further configured to: before sending the second request message to the second network device, send a third request message to the second network device, wherein the third request message includes at least the first communication configuration; and
the first receiving module 120 is further configured to receive a third response message which is returned by the second network device based on the third request message.

In some embodiment, the third request message further includes at least one of:
type information of the sensing module;
a sensing field of view of the sensing module;
a sensing direction of the sensing module; or
sensing capability information of the sensing module.

In some embodiment, the sensing configuration includes at least one of:
a sensing parameter;
a validity period of the sensing parameter; or
information for an update trigger event.

In some embodiment, the first sending module 110 is further configured to: when the validity period of the sensing parameter expires or the update trigger event occurs, resend the second request message to the second network device.

In some embodiment, the update trigger event includes at least one of:
a sensing interference being greater than an interference threshold;
accuracy of the sensing result being less than an accuracy threshold; or
a congestion status at a location of the terminal meeting a preset congestion condition.

In some embodiment, the sensing configuration is provided by the second network device when the terminal is authorized for sensing.

In some embodiment, the first sending module 110 is further configured to: provide the first communication configuration to a corresponding sensing module; and
the first receiving module 120 is further configured to receive the second request message and/or the third request message generated by the sensing module based on the first configuration information.

In some embodiment, the apparatus further includes:
an obtaining module configured to obtain, from the sensing module, an information content carried by the third request message; and
a generation module configured to, according to the first communication configuration, generate the third request message to be sent to the second network device.

In some embodiment, the apparatus further performs:
obtaining, from the sensing module, an information content carried by the second request message; and
according to the first communication configuration, generating the second request message to be sent to the second network device.

As shown in FIG. 11, an embodiment of the present disclosure provides a wireless sensing processing apparatus. The apparatus includes a second receiving module 210, a second sending module 220, an execution module 230 and a providing module 240.

The second receiving module 210 is configured to receive a first communication configuration provided by a communication module of a terminal.

The second sending module 220 is configured to, based on the first communication configuration, provide, to the communication module, a second request message to be sent.

The second receiving module 210 is configured to, receive, from the communication module, a sensing configuration returned based on a second response message for the second request message.

The execution module 230 is configured to perform wireless sensing according to the sensing configuration and obtain a sensing result.

The providing module 240 is configured to provide the sensing result to a driving assistance system.

In some embodiments, the wireless sensing processing apparatus may be the wireless sensing module described above.

In some embodiments, the second receiving module 210, the second sending module 220, the execution module 230 and the providing module 240 may be program modules; after the program modules are executed by a processor, the operations of the above modules can be implemented.

In some embodiments, the second receiving module 210, the second sending module 220, the execution module 230 and the providing module 240 may be a combination of software and hardware modules; the combination of software and hardware modules includes but is not limited to: a programmable array; the programmable array includes but is not limited to a field programmable array and/or a complex programmable array.

In some other embodiments, the second receiving module 210, the second sending module 220, the execution module 230 and the providing module 240 may also include pure hardware modules, and the pure hardware modules include but are not limited to: application specific integrated circuits.

In some embodiments, the third sending module is further configured to: after receiving the first communication configuration, send a third request message to the communication module; and
the third receiving module is further configured to receive, from the communication module, a completion notification provided based on a third response message for the third request message.

In some embodiments, information of the third request message at least includes the first communication configuration, and the third request message further includes at least one of:
a sensing field of view of the sensing module;
a sensing direction of the sensing module; or
sensing capability information of the sensing module.

In some embodiments, information required for the second request message includes at least one of:
a sensing field of view of the sensing module;
a sensing direction of the sensing module;
sensing capability information of the sensing module;
sensing demand information;
location information of the terminal;
a motion velocity of the terminal; or
a motion trajectory of the terminal.

In some embodiments, the sensing configuration includes at least one of:
a sensing parameter;
a validity period of the sensing parameter; or
information for an update trigger event.

In some embodiments, the second sending module 220 is configured to: when the validity period of the sensing parameter expires or the update trigger event occurs, resend the second request message to the communication module.

In some embodiments, the update trigger event includes at least one of:
a sensing interference being greater than an interference threshold;
accuracy of the sensing result being less than an accuracy threshold; or
a congestion status at a location of the terminal meeting a preset congestion condition.

As shown in FIG. 12, an embodiment of the present disclosure provides a wireless sensing processing apparatus. The apparatus includes a third receiving module 310 and a third receiving module 320.

The third receiving module 310 is configured to receive a first request message sent by a terminal;
the third sending module 320 is configured to return a first response message to the terminal based on the first request message, wherein the first response message includes a first communication configuration, and first communication configurations corresponding to different sensing modules in the terminal are different;
wherein the first communication configuration is used for a communication module of the terminal to obtain, from a second network device, sensing configurations for different sensing modules.

In some embodiments, the wireless sensing process apparatus may be included in a first network device.

In some embodiments, the third receiving module 310 and the third receiving module 320 may be program modules; after the program modules are executed by a processor, the operations of the above modules can be implemented.

In some embodiments, the third receiving module 310 and the third receiving module 320 may be a combination of software and hardware modules; the combination of software and hardware modules includes but is not limited to: a programmable array; the programmable array includes but is not limited to a field programmable array and/or a complex programmable array.

In some other embodiments, the third receiving module 310 and the third receiving module 320 may also include pure hardware modules, and the pure hardware modules include but are not limited to: application specific integrated circuits.

In some embodiments, the first response message further includes a second communication configuration, and the second communication configuration is used for communication of the communication module.

In some embodiments, the first request message includes at least one:
first information indicating whether the terminal includes the sensing module;
second information indicating the number of the sensing module(s) included in the terminal;
third information indicating the number of the sensing module in the terminal that is turned on.

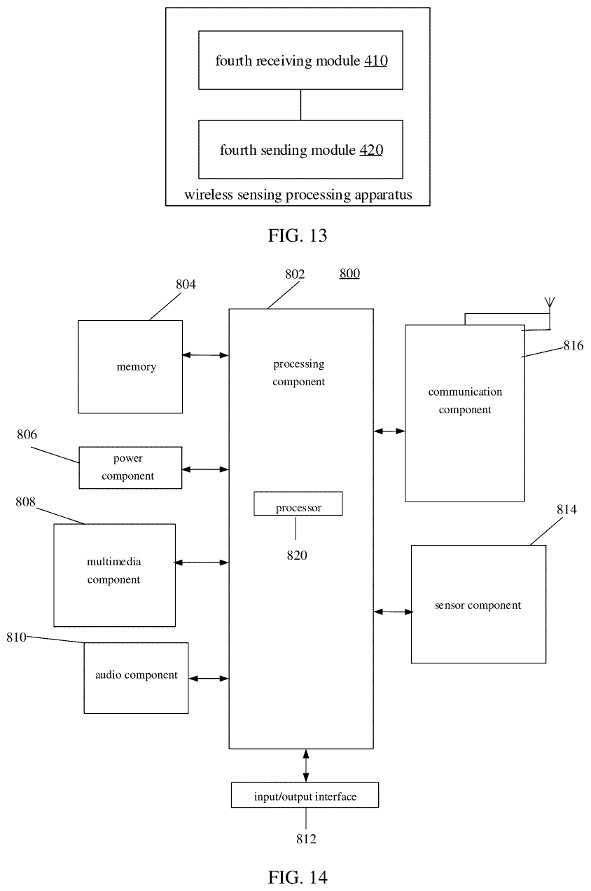

As shown in FIG. 13, an embodiment of the present disclosure provides a wireless sensing processing apparatus. The apparatus includes a fourth receiving module 410 and a fourth sending module 420.

The fourth receiving module 410 is configured to receive a second request message sent by a terminal, wherein the second request message is sent based on a second communication configuration, and different sensing modules in the terminal correspond to different first communication configurations; and
the fourth sending module 420 is configured to return a second response message to the terminal based on the second request message, wherein the second response message includes a sensing configuration, and the sensing configuration is used for the sensing module to obtain a sensing result based on wireless sensing and provide the sensing result to a driving assistance system of the terminal.

In some embodiments, the wireless sensing processing apparatus may be included in a second network device.

In some embodiments, the fourth receiving module 410 and the fourth sending module 420 may be program modules; after the program modules are executed by a processor, the operations of the above modules can be implemented.

In some embodiments, the fourth receiving module 410 and the fourth sending module 420 may be a combination of software and hardware modules; the combination of software and hardware modules includes but is not limited to: a programmable array; the programmable array includes but is not limited to a field programmable array and/or a complex programmable array.

In some other embodiments, the fourth receiving module 410 and the fourth sending module 420 may also include pure hardware modules, and the pure hardware modules include but are not limited to: application specific integrated circuits.

In some embodiments, the fourth receiving module 410 is configured to: receive a third request message from the terminal, wherein the third request message includes a second communication configuration for a sensing module; and
the fourth sending module 420 is configured to return a third response message to the terminal based on the third request message.

In some embodiments, the apparatus further includes:
an authenticating module configured to authenticate the terminal;
the fourth sending module 420 is configured to: after authentication of the terminal is passed, return the second response message to the terminal based on the second request message.

In some embodiments, information of the third request message includes at least one of:
the first communication configuration;
a sensing field of view of the sensing module;
a sensing direction of the sensing module; or
sensing capability information of the sensing module.

In some embodiments, information required for the second request message includes at least one of:
a sensing field of view of the sensing module;
a sensing direction of the sensing module;
sensing capability information of the sensing module;
sensing demand information;
location information of the terminal;
a motion velocity of the terminal; or
a motion trajectory of the terminal.

In some embodiments, the sensing configuration includes at least one of:
a sensing parameter;
a validity period of the sensing parameter; or
information for update trigger event.

An embodiment of the present disclosure provides a communication device, including:
a memory for storing processor-executable instructions; and
a processor connected with the memory;
where the processor is configured to implement the wireless sensing processing method provided by any of the aforementioned technical solutions.

The processor may include various types of storage medium, which are non-transitory computer storage medium that can continue to memorize information stored thereon after the communication device is powered off.

Here, the communication device includes: a terminal, a wireless sensing module, a first network device and/or a second network device.

The processor may be connected to the memory via a bus or the like, and is configured to read an executable program stored in the memory, for example, at least one of the methods shown in FIG. 2, FIG. 4 to FIG. 9.

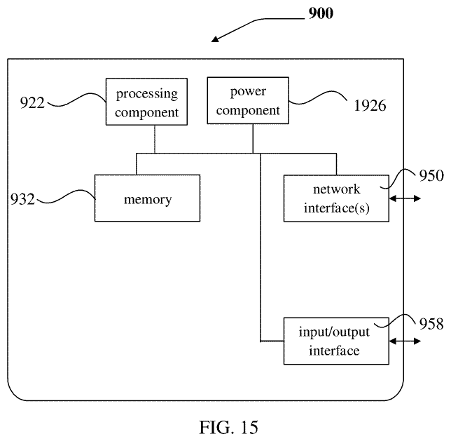

FIG. 14 is a block diagram of a terminal 800 according to an example embodiment. For example, the terminal 800 may be a mobile phone, a computer, digital broadcast user equipment, a messaging device, a gaming console, a tablet, a medical device, exercise equipment, a personal digital assistant, and the like.

Referring to FIG. 14, the terminal 800 may include one or more of the following components: a processing component 801, a memory 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal 800. Examples of such data include instructions for any applications or methods operated on the terminal 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 800 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 800. For instance, the sensor component 814 may detect an open/closed status of the terminal 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal 800 and other devices. The terminal 800 can access a wireless network based on a communication standard, such as WiFi, 2G, or 3G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the terminal 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the terminal 800, for performing the above-described methods. For example, the non-transitory computer-readable storage medium may be a ROM, a Random Access Memory (RAM), a CD-ROM, a magnetic tape, a floppy disc, an optical data storage device, and the like.

As shown in FIG. 15, an embodiment of the present disclosure shows a structure of a network device. For example, a network device 900 may be provided as a network side device, for example, including but not limited to a core network device.

Referring to FIG. 15, the network device 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods which are applied at the network device, for example, at least one of the methods shown in FIG. 2, and FIG. 4 to FIG. 9.

The network device 900 may also include a power component 926 configured to perform power management of the network device 900, wired or wireless network interface(s) 950 configured to connect the network device 900 to a network, and an input/output (I/O) interface 958. The network device 900 may operate based on an operating system stored in the memory 932, such as Windows Server™, Mac OS X™, Unix™, Linux™, FreeBSD™, or the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A wireless sensing processing method, performed by a communication module of a terminal and the method comprising:
sending a first request message to a first network device according to module information of at least one sensing module of the terminal;
receiving a first response message returned by the first network device based on the first request message, wherein the first response message comprises a first communication configuration provided for the sensing module, wherein the sensing module has at least one of a transmitting capability of transmitting a sensing signal or a receiving capability of receiving a reflected signal returned based on the sensing signal acting on a sensing target;
sending a second request message generated based on the first communication configuration to a second network device; and
receiving a second response message returned by the second network device based on the second request message, wherein the second response message comprises a sensing configuration;
wherein the sensing configuration is configured for the sensing module to generate a sensing result based on wireless sensing and provide the sensing result to a driving assistance system of the terminal.

2. The method according to claim 1, wherein the first communication configuration comprises an Internet Protocol (IP) address, and IP addresses corresponding to different sensing modules are different.

3. The method according to claim 2, wherein the first response message further comprises a second communication configuration, and the second communication configuration is configured for communication of the communication module.

4. The method according to claim 1, wherein the first request message comprises at least one of:
first information indicating whether the terminal comprises the sensing module;
second information indicating a number of the at least one sensing module comprised in the terminal; or
third information indicating a number of at least one sensing module in the terminal that is turned on.

5. The method according to claim 1, wherein the second request message comprises at least one of:
type information of the sensing module;
a sensing field of view of the sensing module;
a sensing direction of the sensing module;
sensing capability information of the sensing module;
sensing demand information;
location information of the terminal;
a motion velocity of the terminal; or
a motion trajectory of the terminal.

6. The method according to claim 5, wherein the sensing capability information comprises at least one of:
a sensing model supported by the sensing module;
a radio frequency supported by the sensing module;
a sensing range supported by the sensing module; or
a maximum sensing power supported by the sensing module; or
wherein the sensing demand information indicates at least one of:
a radio frequency expected to be used;
a sensing signal transmit frequency expected to be used; or
required accuracy of the sensing result.

7. (canceled)

8. The method according to claim 1, wherein sending the second request message generated based on the first communication configuration to the second network device comprises:
in response to the driving assistance system having a demand for obtaining the sensing result, sending the second request message generated based on the first communication configuration to the second network device;
wherein the driving assistance system having the demand for obtaining the sensing result comprises at least one of:
the driving assistance system entering a working state;
a motion velocity of the terminal reaching a preset velocity; or
at least one of the sensing module or the communication module receiving, from the driving assistance system, demand information for obtaining the sensing result.

9. (canceled)

10. The method according to claim 1, further comprising:
before sending the second request message to the second network device, sending a third request message to the second network device, wherein the third request message comprises at least the first communication configuration; and
receiving a third response message returned by the second network device based on the third request message;
wherein the third request message further comprises at least one of:
type information of the sensing module;
a sensing field of view of the sensing module;
a sensing direction of the sensing module; or
sensing capability information of the sensing module.

11. (canceled)

12. The method according to claim 1, wherein the sensing configuration comprises at least one of:
a sensing parameter;
a validity period of the sensing parameter; or
information for an update trigger event;
wherein the method further comprises: when the validity period of the sensing parameter expires or the update trigger event occurs, resending the second request message to the second network device, or
wherein the update trigger event comprises at least one of:
a sensing interference being greater than an interference threshold;
accuracy of the sensing result being less than an accuracy threshold; or
a congestion status at a location of the terminal meeting a preset congestion condition.

13.-15. (canceled)

16. The method according to claim 10, further comprising:
providing the first communication configuration to a corresponding sensing module; and
receiving at least one of the second request message or the third request message generated by the corresponding sensing module based on the first communication configuration; or
wherein the method further comprises:
obtaining, from the sensing module, an information content carried by the third request message; and
according to the first communication configuration, generating the third request message to be sent to the second network device.

17. (canceled)

18. The method according to claim 1, further comprising:
obtaining, from the sensing module, an information content carried by the second request message; and
according to the first communication configuration, generating the second request message to be sent to the second network device.

19. A wireless sensing processing method, performed by a sensing module of a terminal, wherein the sensing module has a capability of transmitting a sensing signal and receiving a reflected signal returned based on the sensing signal acting on a sensing target, and the method comprises:
receiving a first communication configuration provided by a communication module of the terminal;
based on the first communication configuration, providing, to the communication module, a second request message to be sent;
receiving, from the communication module, a sensing configuration returned based on a second response message for the second request message;
performing wireless sensing according to the sensing configuration and obtaining a sensing result; and
providing the sensing result to a driving assistance system.

20. The method according to claim 19, further comprising:
after receiving the first communication configuration, sending a third request message to the communication module; and
receiving, from the communication module, a completion notification provided based on a third response message for the third request message.

21. The method according to claim 20, wherein information of the third request message at least comprises the first communication configuration, and the third request message further comprises at least one of:
a sensing field of view of the sensing module;
a sensing direction of the sensing module; or sensing capability information of the sensing module.

22. The method according to claim 19, wherein information required for the second request message comprises at least one of:
a sensing field of view of the sensing module;
a sensing direction of the sensing module;
sensing capability information of the sensing module;
sensing demand information;
location information of the terminal;
a motion velocity of the terminal; or
a motion trajectory of the terminal.

23. The method according to claim 19, wherein the sensing configuration comprises at least one of:
a sensing parameter;
a validity period of the sensing parameter; or
information for an update trigger event.

24. (canceled)

25. (canceled)

26. A wireless sensing processing method, performed by a first network device and the method comprising:
receiving a first request message sent by a terminal;
returning a first response message to the terminal based on the first request message, wherein the first response message comprises a first communication configuration, and first communication configurations corresponding to different sensing modules in the terminal are different;
wherein the first communication configuration is configured for a communication module of the terminal to obtain, from a second network device, sensing configurations for different sensing modules.

27.-38. (canceled)

39. A communication device, comprising:
a processor;
a transceiver; and
a memory storing a program executable by the processor, wherein the processor, is configured to perform the method of claim 1.

40. (canceled)

41. A communication device, comprising:
a processor;
a transceiver; and
a memory storing a program executable by the processor,
wherein the processor is configured to perform the method of claim 19.

42. A communication device, comprising:
a processor;
a transceiver; and
a memory storing a program executable by the processor,
wherein the processor is configured to perform the method of claim 26.
